(19) United States
(12) Patent Application Publication
(10) Pub. No.: US 2021/0342021 A1
(43) Pub. Date: Nov. 4, 2021

(54) COMPUTER MOUSE INCLUDING TOUCH-SENSITIVE BUTTON AND FINGER REST

(71) Applicant: Jinwoo Jang, Glen Ellyn, IL (US)

(72) Inventor: Jinwoo Jang, Glen Ellyn, IL (US)

(21) Appl. No.: 17/246,718

(22) Filed: May 3, 2021

Related U.S. Application Data
(60) Provisional application No. 63/019,153, filed on May 1, 2020.

(51) Int. Cl. G06F 3/0354; G06F 3/045

(52) U.S. Cl. CPC G06F 3/03543; G06F 3/044; G06F 3/045; G06F 3/03547

(57) ABSTRACT

The present disclosure provides a computer mouse or similar input device including at least one touch-sensitive pad, such as a capacitance-based pad or a resistance-based touchpad; and at least one finger rest, and methods of using same.

### PRIORITY CLAIM

This application claims priority to U.S. Provisional Patent Application Ser. No. 63/019,153, filed May 1, 2020, the entire contents of which are incorporated herein by reference and relied on.

### FIELD

The present disclosure provides a computer mouse or similar input device including at least one touch-sensitive pad, such as a capacitance-based pad or a resistance-based touchpad; and at least one finger rest, and methods of using same.

### BACKGROUND

Existing computer input devices, such as the computer mouse device, typically require application of significant force to a tangible button (e.g., mechanical button) in order to overcome a threshold resistance barrier. Repeated application of such force can cause pain and/or stress to the user's finger(s), and creates an audible “click” sound that may be undesirable in certain environments.

A need persists for accurate and easy-to-use computer input devices that do not require a user to repeatedly overcome a significant threshold force barrier.

### SUMMARY

The present disclosure provides a computer mouse or similar input device including at least one touch-sensitive button and at least one finger rest, and methods of using same.

In some embodiments, the present disclosure provides a computer mouse comprising: an x-y tracking component configured to track movement of the computer mouse relative to a surface; a first touch-sensitive pad configured to receive an input signal based on contact between the first touch-sensitive pad and a finger of a user; and a first finger rest disposed proximate to the first touch-sensitive pad and configured to enable the user to rest the finger thereupon to prevent unintended contact between the finger and the first touch-sensitive pad and without enabling an input signal to be received by the computer mouse based on contact between the first finger rest and the finger of the user.

In other embodiments, the present disclosure provides a computer mouse comprising: an x-y tracking component configured to track movement of the computer mouse relative to a surface; a first touch-sensitive pad configured to receive an input signal based on contact between the first touch-sensitive pad and a finger of a user; a second button functionally isolated from the first touch-sensitive pad and configured to receive an input signal based on contact between the second button and a finger of a user; and a finger rest disposed proximate to the first touch-sensitive pad and proximate to the second button, and configured to enable the user to rest the finger thereupon to prevent unintended contact between the finger and the first touch-sensitive pad and without enabling an input signal to be received by the computer mouse based on contact between the finger rest and the finger of the user, wherein the first touch-sensitive pad does not generate an audible clicking sound when contacted by the finger of the user.

These and other embodiments are described in greater detail below with respect to the accompanying figures.

### BRIEF DESCRIPTION OF THE FIGURES

FIG. 1 shows a computer mouse including a touch-sensitive button and a finger rest consistent with one embodiment of the present disclosure.

FIG. 2 shows a side view of the computer mouse of FIG. 1.

FIG. 3A shows a top view of the computer mouse of FIG. 1.

FIG. 3B shows a bottom view of the computer mouse of FIG. 1.

FIG. 4 shows a computer mouse including a touch-sensitive button and a finger rest consistent with another embodiment of the present disclosure.

FIG. 5 shows a side view of the computer mouse of FIG. 4.

FIG. 6 shows a top view of the computer mouse of FIG. 4.

FIG. 7 shows a computer mouse including a touch-sensitive button and a finger rest consistent with another embodiment of the present disclosure.

FIG. 8 shows a side view of the computer mouse of FIG. 7.

FIG. 9 shows a top view of the computer mouse of FIG. 7

FIG. 10 shows a computer mouse including a touch-sensitive button and a finger rest consistent with another embodiment of the present disclosure.

FIG. 11 shows a side view of the computer mouse of FIG. 10.

FIG. 12 shows a top view of the computer mouse of FIG. 10.

FIG. 13 shows one embodiment of a finger rest suitable for inclusion in a computer mouse consistent with the present disclosure.

FIG. 14 shows another embodiment of a finger rest suitable for inclusion in a computer mouse consistent with the present disclosure.

FIG. 15 shows a front view of another embodiment of a finger rest suitable for inclusion in a computer mouse consistent with the present disclosure

FIG. 16 shows a side view of the finger rest of FIG. 15.

FIG. 17 shows a top view of a computer mouse consistent with one embodiment of the present disclosure including a touch-sensitive button (right), a clickable button (left), and a scroll wheel disposed therebetween.

FIG. 18 shows a top view of a computer mouse consistent with another embodiment of the present disclosure including a clickable button (right), a touch-sensitive button (left), and a scroll wheel disposed therebetween.

FIG. 19 shows one embodiment of a touch-sensitive button suitable for inclusion in a computer mouse consistent with the present disclosure.

FIG. 20 shows another embodiment of a touch-sensitive button suitable for inclusion in a computer mouse consistent with the present disclosure.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

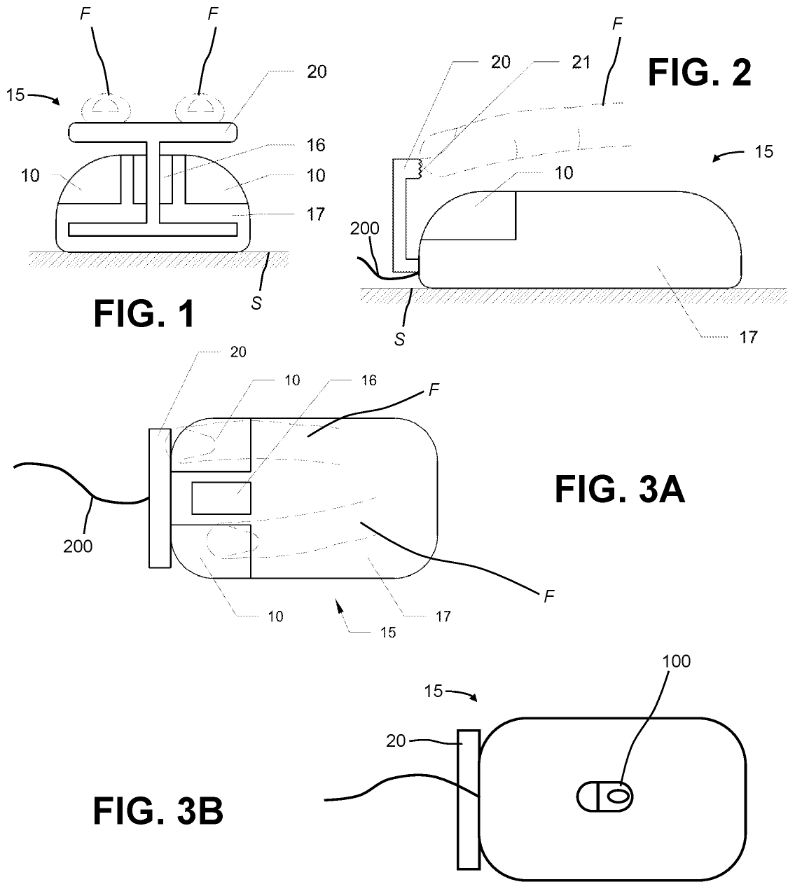

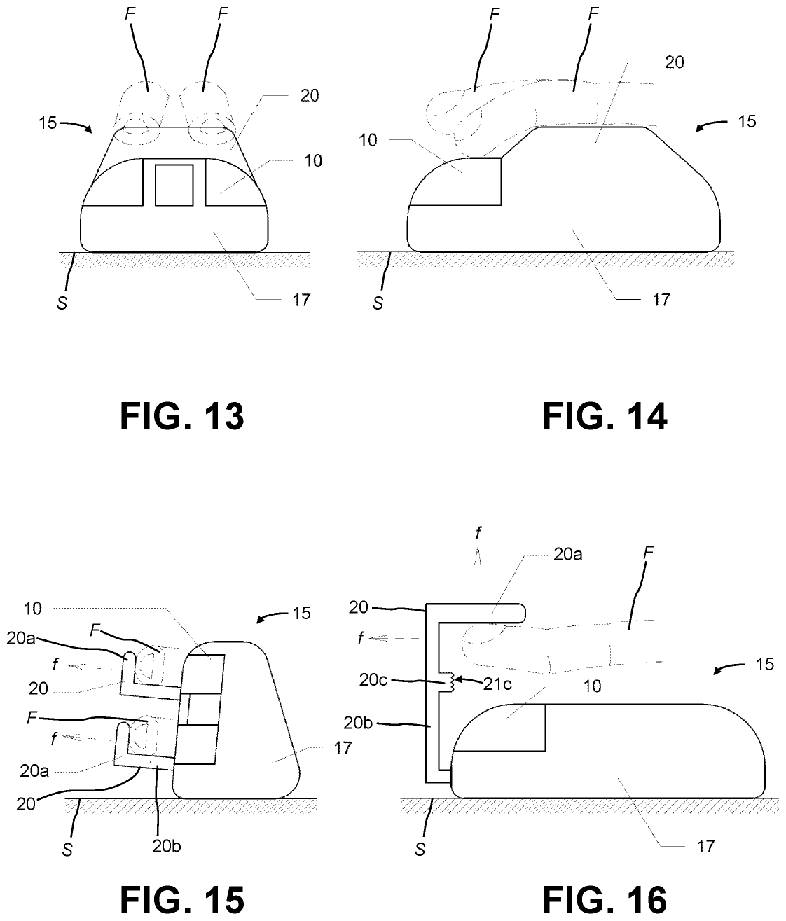

Referring generally to FIGS. 1-20, the present disclosure provides a computer mouse or similar input device including at least one touch-sensitive button and at least one finger rest, and methods of using same.

In general, computer mice 15 consistent with the present disclosure include a touch-sensitive pad 10 and a finger rest 20.

The touch-sensitive pad 10 is configured to receive an input signal from the user, for example based on contact between the touch-sensitive pad 10 and a finger F of a user. For example and without limitation, the touch-sensitive pad 10 may comprise a capacitance-based touchpad, or a resistance-based pad or screen. In some embodiments, the touch-sensitive pad 10 is operable to not generate an audible clicking sound when the finger F taps, presses, or presses and releases the touch-sensitive pad 10.

The input signal may be, or an associated computer may be configured to translate the input signal to, essentially any desired action. For example and without limitation, the input signal may correspond to a left button click signal from a conventional Windows mouse (e.g., a selection input signal), a right button click signal from a conventional Windows mouse (e.g., prompting display of a menu or submenu of options), a scroll wheel button input from a conventional Windows mouse (e.g., to engage a navigational control setting), a scroll wheel spin signal (e.g., to cause an associated display to scroll the visual information up, down, left or right), etc.

The finger rest 20 is generally disposed proximate to the touch-sensitive pad(s) 10 and is configured to enable the user to rest the finger F thereupon to prevent unintended contact between the finger F and the touch-sensitive pad(s) 10. Users of conventional computer mice that include mechanical (“click”-type) buttons can rest finger(s) on top of the mechanical buttons without activating the mechanical button (e.g., without generating an input signal). However, resting a finger F on a touch-sensitive pad 10 generally activates the touch-sensitive pad 10 (e.g., generates an input signal). The finger rest 20 enables the user to rest a finger F on the finger rest 20 without activating the touch-sensitive pad 10 (e.g., without generating an input signal). The finger rest 20 is isolated electrically from the touch-sensitive pad 10. That is, in embodiments wherein the touch-sensitive pad 10 is a capacitance-based touchpad, contacting the finger rest 20 with a finger F does not change the capacitance of the touchpad enough to generate an input signal. In embodiments wherein the touch-sensitive pad 10 is a resistance-based pad or screen, contacting the finger rest 20 with a finger F does not change the resistance of the pad or screen enough to generate an input signal.

In some embodiments, performance of the touch-sensitive pad 10 is customizable. For example and without limitation, the computer mouse 15 may transmit a signal to an associated computer when the touch-sensitive pad 10 is contacted by a finger F, for example via a wireless protocol or by a wire 200. The associated computer may include software protocols that, when executed, enable the user to adjust parameters or assign actions to the input signal(s) associated with contact between a finger F and the touch-sensitive pad(s) 10. In some embodiments, the touch-sensitive pad 10 is customizable to enable the user to determine a touch sensitivity level below which contact between the first touch-sensitive pad and a finger of the user will not be received as an input signal (e.g., a threshold minimum sensitivity level). In some embodiments, the touch-sensitive pad 10 is customizable to enable the user to determine an action performed when the touch-sensitive pad 10 receives an input signal (e.g., when the user's finger F contacts the touch-sensitive pad 10). In some embodiments, the touch-sensitive pad 10 is customizable to enable the user to specify an action performed by the associated computer when the user contacts the touch-sensitive pad 10 with a finger F and then drags the finger F while it is still in contact with the touch-sensitive pad 10 (e.g., as represented graphically in FIG. 19).

In embodiments wherein the computer mouse 15 includes two touch-sensitive pads 10, the user may specify an action performed by the associated computer when both touch-sensitive pads 10 are contacted by the user's finger Fat substantially the same time (e.g., simultaneously). In embodiments wherein the computer mouse 15 includes two touch-sensitive pads 10, the user may specify an action performed by the associated computer when the user lifts fingers F away from both touch-sensitive pads 10 at substantially the same time (e.g., simultaneously).

In some embodiments, the finger rest 20 includes a texture 21 on at least a portion of the finger rest 20 surface. The texture 21, when present, can improve purchase of the finger F on the finger rest 20, for example to reduce or eliminate slippage of the finger F and resulting unintended contact between the finger F and the touch-sensitive pad 10.

The finger rest 20 may comprise, consist essentially of, or consist of any suitable material that provides operable isolation of the finger rest 20 from the touch-sensitive pad 20, and that provides sufficient structural integrity to prevent pressure from the finger F from deflecting or destroying the finger rest 20. For example and without limitation, the finger rest 20 may comprise, consist essentially of, or consist of plastic, steel, aluminum, or any combination thereof. In some embodiments, the finger stand 20 is flexible. In some embodiments, the position of the finger stand 20 is adjustable, for example by bending the finger stand 20 away from an initial position to accommodate larger fingers F.

In some embodiments, the finger rest 20 includes a guard 20a configured to provide a resistive force against the finger F when the user moves the finger F away from the touch-sensitive pad(s) 10. In some embodiments, the guard 20a is disposed distal to the touch-sensitive pad(s) 10. For example, the guard 20a may be disposed at an angle (e.g., at an acute angle, at an obtuse angle, or generally orthogonal) to a finger rest member 20b. The guard 20a provides resistance against force f applied on the guard 20a by the user's finger F, and thus increases stability of the finger F in its resting position.

In some embodiments, the computer mouse 15 includes one finger rest 20. In such embodiments, the one finger rest 20 may be configured to enable one finger F, two fingers F, or three fingers F to rest thereupon. For example and without limitation, the computer mice 15 specifically illustrated in FIGS. 1-6 and 13-14 depict three examples of single finger rests 20 each configured to enable two fingers F to rest thereupon, while the computer mouse 15 specifically illustrated in FIG. 16 depicts one example of a single finger rest 20 configured to enable only one finger F to rest thereupon.

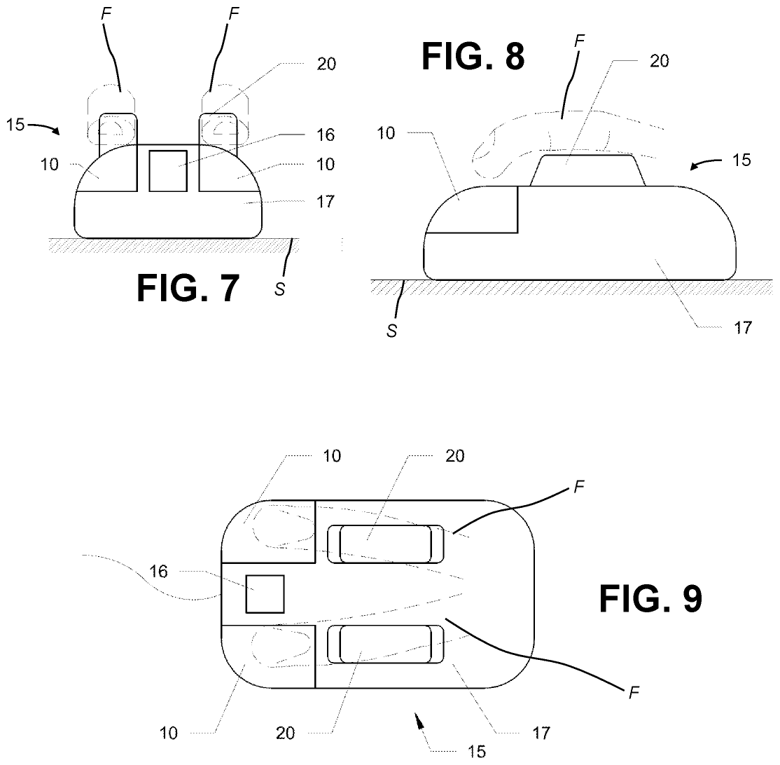

In other embodiments, the computer mouse includes two finger rests 20. In such embodiments, each of the two finger rests 20 may be configured to enable one finger F or more than one finger F to rest thereupon. For example and without limitation, the computer mice 15 specifically illustrated in FIGS. 7-12 and 15 depict three examples of two finger rests 20 each configured to enable only one finger F to rest thereupon.

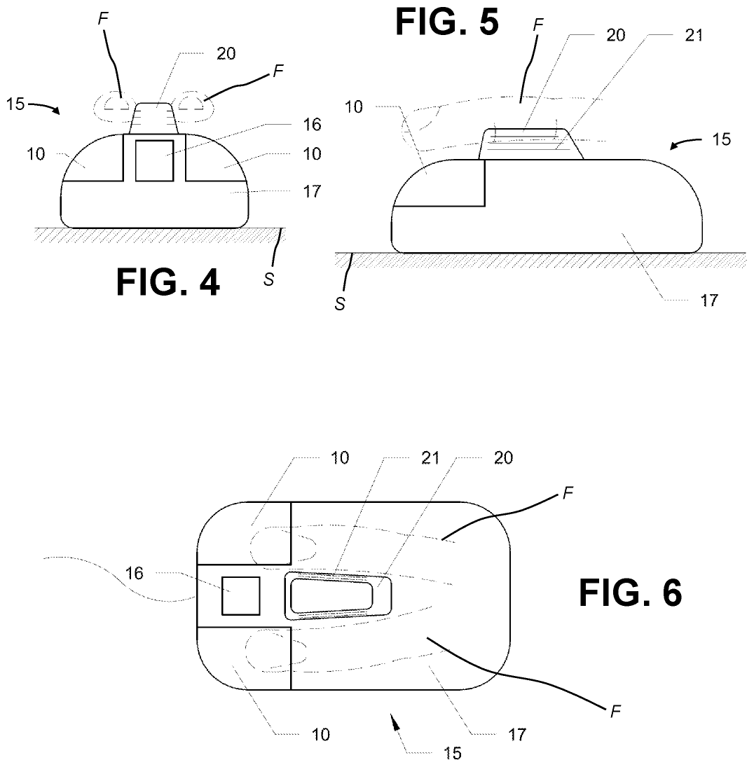

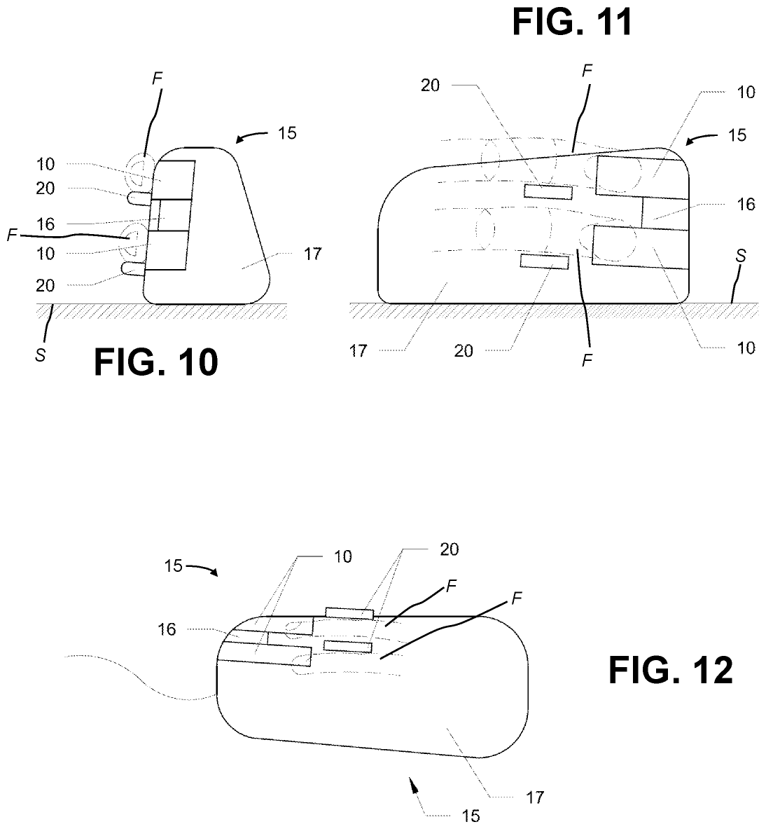

The finger rest 20 may include a cross-sectional shape suitable to enable the finger F to rest distal from the touch-sensitive pad 10. For example and without limitation, the cross-section shape may be substantially T-shaped, substantially I-shaped (e.g., FIGS. 1-3B and 13-14), substantially rectangular (e.g., FIGS. 7-9), substantially square, substantially trapezoidal (e.g., FIGS. 4-6), substantially semicircular, substantially semi-ovular, substantially semi-ellipsoidal, substantially half-pill-shaped (e.g., FIGS. 10-12), substantially L-shaped (e.g., FIG. 15), or substantially C-shaped (e.g., FIG. 16).

In some embodiments, the finger rest 20 may further comprise one or more protrusions 20c disposed proximal to the touch-sensitive pad 10 configured to provide additional surface(s) against which to rest a finger F. In some embodiments, the protrusion 20c includes a texture 21c on at least a portion of its surface. When present, the texture 21c improves purchase of the finger F to reduce or eliminate unintended contact between the finger F and the touch-sensitive pad 10. The protrusion 20c in some embodiments provides, when contacted by the finger F, information to the user about spatial relationship (e.g., proximity information) between the finger F and the nearby touch-sensitive pad(s) 10 to reduce unintended contact between the finger F and the touch-sensitive pad(s) 10. The presence of one or more protrusions is especially advantageous in this way in embodiments that include more than one touch-sensitive pad 10.

The computer mouse 15 may include a housing 17 in which the touch-sensitive pad 10 is disposed, and with which the finger rest 20 is associated. In some embodiments, such as those generally consistent with those specifically illustrated in FIGS. 1-3B and 15-16, the finger rest(s) 20 extends from the housing 17. In other embodiments, such as those generally consistent with those specifically illustrated in FIGS. 4-14, the finger rest(s) 20 are incorporated into the housing 17 as contours of the housing 17.

In some embodiments, the finger rest 20 is disposed generally on a lateral side of the housing 17. For example and without limitation, the computer mice 15 specifically illustrated in FIGS. 10-12 and 15 depict embodiments in which the finger rest(s) 20 is disposed on a lateral side of the housing 17.

In other embodiments, the finger rest 20 is disposed generally on a front end of the housing 17. For example and without limitation, the computer mice 15 specifically illustrated in FIGS. 1-3B and 16 depict embodiments in which the finger rest(s) 20 is disposed on a front end of the housing 17.

In still other embodiments, the finger rest 20 is disposed generally on a top side of the housing 17. For example and without limitation, the computer mice 15 specifically illustrated in FIGS. 4-9 and 13-14 depict embodiments in which the finger rest(s) 20 is disposed on a front end of the housing 17.

In some embodiments, the finger rest 20 is detachable from the housing 17. In some such embodiments, the finger rest 20 is sized and shaped to securely attach to a computer mouse 15 by pressing the finger rest 20 over at least a portion of the housing 17. In some embodiments, the finger rest 20 is securable in such a manner without the use of mechanical fasteners and/or without adhesive.

In some embodiments, the finger rest 20 is attachable to a computer mouse 15 by one o more mechanical fasteners (e.g., screws, posts, or magnets). In some embodiments, the finger rest 20 is attachable to a computer mouse 15 by adhesive (e.g., by glue or two-sided adhesive tape).

In some embodiments, the finger rest 20 is integrated (e.g., manufactured as one component) with the housing 17.

Computer mice 15 consistent with the present disclosure may also include an x-y tracking component 100. When present, the x-y tracking component 100 is configured to enable the user to manipulate a pointer (e.g., cursor, arrow, or other selection icon) on a computer screen associated with the computer mouse 15. In some embodiments, the x-y tracking component 100 may include components configured to enable the computer mouse 15 to track movement of the computer mouse 15 relative to a surface S. For example and without limitation, the x-y tracking component 100 may include a laser lamp, lenses, and a sensor configured to detect movement of the computer mouse 15 across the surface S. In other embodiments, the x-y tracking component 100 may include a trackball (not shown), for example for a computer mouse 15 that is intended to be used in a generally stationary position. In still other embodiments, the x-y tracking component 100 comprises a resistance-based pad, such as a touch-sensitive pad 10 as described herein. In still other embodiments, the x-y tracking component 100 comprises a capacitance-based pad or screen, such as a touch-sensitive pad 10 as described herein.

In some embodiments, the computer mouse 15 further includes a scroll wheel 16 configured to enable a user to provide scrolling or other navigational inputs to an associated computer.

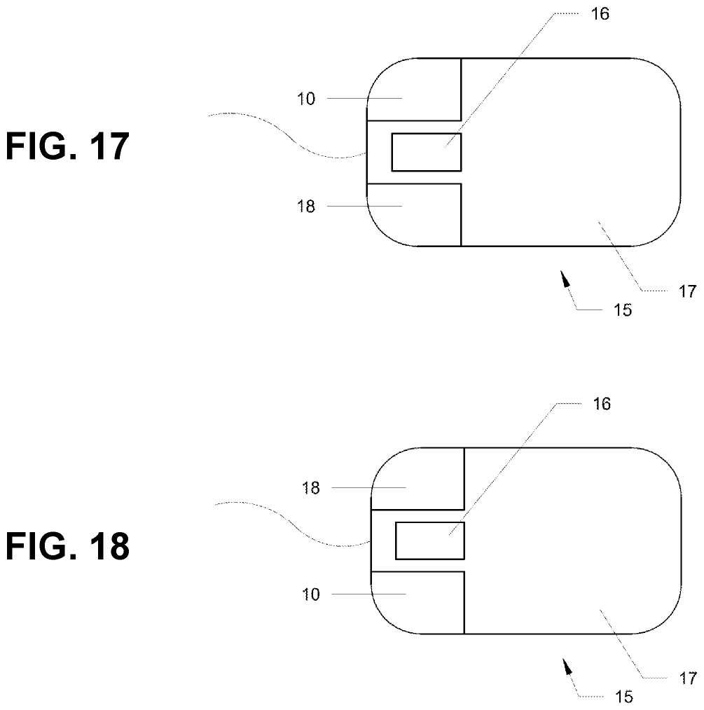

Referring now specifically to FIGS. 17-18, a computer mouse 15 consistent with the present disclosure may include a touch-sensitive pad 10, a mechanical button 18, and one or more finger rests 20 (not shown for clarity). In one embodiment, the touch-sensitive pad 10 is disposed on the right portion of the top surface of the housing 17, while the mechanical button 18 is disposed on the left portion of the top surface of the housing 17 (e.g., FIG. 17). In another embodiment, the touch-sensitive pad 10 is disposed on the left portion of the top side of the housing 17, while the mechanical button is disposed on the right portion of the top side of the housing 17 (e.g., FIG. 18).

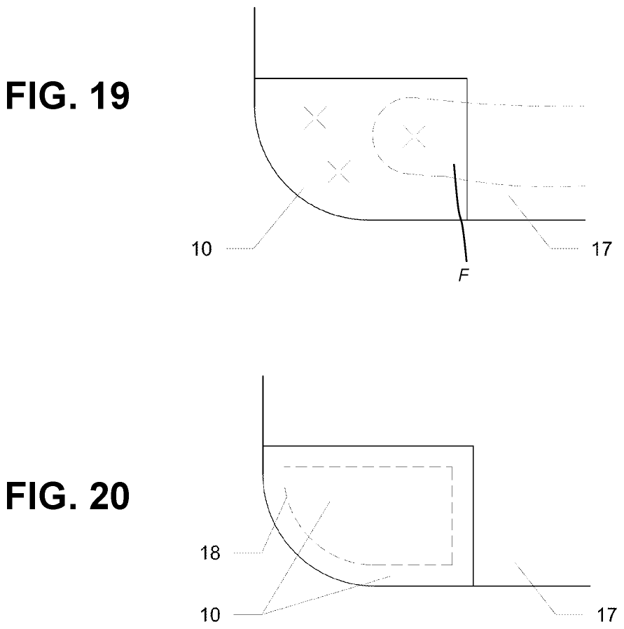

Referring now to FIG. 20, a touch-sensitive pad 10 may be disposed in operable association with (e.g., disposed on top of) a mechanical button 18. When contacted by a finger F with a relatively small force (e.g., below a threshold minimum mechanical activation force), the signal generated by the computer mouse 15 corresponds only to contact between the finger F and the touch-sensitive pad 10. When contacted by a finger F with a comparatively larger force (e.g., above a threshold minimum mechanical activation force), the signal generated by the computer mouse 15 corresponds (e.g., may only correspond) to contact between the finger F and the mechanical button 18.

1. A computer mouse comprising:
an x-y tracking component configured to track movement of the computer mouse relative to a surface;
a first touch-sensitive pad configured to receive an input signal based on contact between the first touch-sensitive pad and a finger of a user; and
a first finger rest disposed proximate to the first touch-sensitive pad and configured to enable the user to rest the finger thereupon to prevent unintended contact between the finger and the first touch-sensitive pad and without enabling an input signal to be received by the computer mouse based on contact between the first finger rest and the finger of the user.

2. The computer mouse of claim 1 further comprising a second touch-sensitive pad functionally isolated from the first touch-sensitive pad, wherein the second touch-sensitive pad is configured to receive an input signal based on contact between the second touch-sensitive pad and a finger of the user.

3. The computer mouse of claim 1, wherein the first finger rest is configured to enable two fingers of the user to rest thereupon to prevent unintended contact between either finger and the first touch-sensitive pad and without enabling an input signal to be received by the computer mouse based on contact between the first finger rest and either of the two fingers of the user.

4. The computer mouse of claim 2 further comprising a second finger rest disposed proximate to the second touch-sensitive pad and configured to enable the user to rest a second finger thereupon to prevent unintended contact between the second finger and the second touch-sensitive pad and without enabling an input signal to be received by the computer mouse based on contact between the second finger rest and the second finger of the user.

5. The computer mouse of claim 1, wherein the first touch-sensitive pad is configured to enable the user to determine a touch sensitivity level below which contact between the first touch-sensitive pad and a finger of the user will not be received as an input signal.

6. (canceled)

7. The computer mouse of claim 1, wherein the first touch-sensitive pad is configured to enable the user to determine an action performed by an associated computer when the first touch-sensitive pad receives an input signal.

8. The computer mouse of claim 2, wherein the second touch-sensitive pad is configured to enable the user to determine an action performed by an associated computer when the second touch-sensitive pad receives an input signal.

9. The computer mouse of claim 2, wherein the first touch-sensitive pad and the second touch-sensitive pad are configured to enable the user to determine an action performed by an associated computer when the first touch-sensitive pad and the second touch-sensitive pad receive input signals at substantially the same time.

10. The computer mouse of claim 2, wherein the first touch-sensitive pad and the second touch-sensitive pad are configured to enable the user to determine an action performed by an associated computer when the first touch-sensitive pad and the second touch-sensitive pad cease receiving input signals at substantially the same time.

11. The computer mouse of claim 1, wherein the first touch-sensitive pad is configured to enable the user to determine an action performed by an associated computer when the first touch-sensitive pad is contacted by a finger of the user followed by a dragging motion of the finger while still in contact with the first touch-sensitive pad.

15. The computer mouse of claim 1, wherein the first finger rest includes a cross-sectional shape that is substantially T-shaped, substantially I-shaped, substantially rectangular, substantially square, substantially trapezoidal, substantially semicircular, substantially semi-ovular, substantially semi-ellipsoidal, substantially half-pill-shaped, substantially L-shaped, or substantially C-shaped.

16. The computer mouse of claim 4, wherein the second finger rest includes a cross-sectional shape that is substantially T-shaped, substantially I-shaped, substantially rectangular, substantially square, substantially trapezoidal, substantially semicircular, substantially semi-ovular, substantially semi-ellipsoidal, substantially half-pill-shaped, substantially L-shaped, or substantially C-shaped.

17. The computer mouse of claim 1, wherein the first finger rest includes a first guard disposed distal to the first touch-sensitive pad and configured to provide a resistive force against the finger when the user moves the finger away from the first touch-sensitive pad.

18. The computer mouse of claim 4, wherein the second finger rest includes a second guard disposed distal to the first touch-sensitive pad or the second touch-sensitive pad, and wherein the second guard is configured to provide a resistive force against the finger when the user moves the finger away from the first touch-sensitive pad or the second touch-sensitive pad.

19. The computer mouse of claim 1, wherein the x-y tracking component includes a laser light, a trackball, a scroll wheel, or a combination of any two or more thereof.

20. The computer mouse of claim 1, wherein the first touch-sensitive pad does not generate an audible clicking sound when contacted by the finger of the user (e.g., is not a mechanical button).

21. (canceled)

22. The computer mouse of claim 1, wherein the first finger rest is disposed on a lateral side of the computer mouse.

23. The computer mouse of claim 1, wherein the first finger rest is disposed on a top side of the computer mouse.

24. The computer mouse of claim 4, wherein the second finger rest is disposed on a lateral side of the computer mouse.

25. The computer mouse of claim 4, wherein the second finger rest is disposed on a top side of the computer mouse.

26-31. (canceled)
